(19) United States
(12) Patent Application Publication
(10) Pub. No.: US 2012/0215656 A1
(43) Pub. Date: Aug. 23, 2012

(54) DRAG-AND-DROP INTERNET SHOPPING WITH AN EMBEDDED SHOPPING CART VIEW

(76) Inventor: Liang Light Chen, (US)

(21) Appl. No.: 13/400,927

(22) Filed: Feb. 21, 2012

Related U.S. Application Data
(60) Provisional application No. 61/445,927, filed on Feb. 23, 2011.

(51) Int. Cl. G06Q 30/06

(52) U.S. Cl. 705/26.8

(57) ABSTRACT

A system and method for managing Internet shopping with an embedded shopping cart view are disclosed. A particular embodiment includes providing, by use of a data processor, a user interface to present a list of items to a user in a first display region; present a moveable virtual shopping cart in a second display region concurrently viewable with the first display region, the virtual shopping cart being moveable within the first display region; enable a user to add items from the list of items by drag/drop or click into the virtual shopping cart; and display a summary of items placed in the virtual shopping cart.

### PRIORITY APPLICATION

This non-provisional patent application claims priority to U.S. provisional patent application Ser. No. 61/445,927; filed on Feb. 23, 2011 by a common inventor as the present patent application. This present patent application draws priority from the referenced provisional patent application. The entire disclosure of the referenced provisional patent application is considered part of the disclosure of the present application and is hereby incorporated by reference herein in its entirety.

### TECHNICAL FIELD

This application relates to a method and system for use with networked computing or communication devices, according to one embodiment, and more specifically, to using networked computing or communication devices for managing drag-and-drop Internet shopping with an embedded shopping cart view.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2010-2012 Liang Light Chen, All Rights Reserved.

### BACKGROUND

Internet shopping websites typically have web browser page(s) displaying the item(s) for sale. During browsing, when the shopper decides to purchase an item, the shopper can place the item(s) into a virtual “shopping cart” by clicking on a link or button typically labeled “add to shopping cart”. The conventional web browser will subsequently change to a new web page to display item(s) that the shopper has placed into their virtual “shopping cart”. The shopper will then have the opportunity to modify the quantities of their purchase, remove the item, continue shopping, or go to checkout to complete their purchase.

This conventional user interface is very inconvenient as it does not allow the shopper to simultaneously view their shopping cart and the item(s) for sale. Although the shopper could at any time view the shopping cart by clicking on a shopping cart icon typically displayed at the top of the page, this icon is almost always obscured as the shopper scrolls down the web page thus making clicking on the shopping cart icon very inconvenient. As a possible work around, the shopper can open the “shopping cart” as a new browser window; but, this may not always display the most current content(s) of the “shopping cart”, because a separate browser window is not always kept updated with the latest information. Again, this is a very cumbersome work around. This kind of conventional user interface is also counter intuitive as it is analogous to requiring the shopper to keep the shopping cart in a separate room away from the store.

### BRIEF DESCRIPTION OF THE DRAWINGS

The various embodiments is illustrated by way of example, and not by way of limitation, in the figures of the accompanying drawings in which:

FIG. 1 illustrates an example embodiment of a system and method for managing drag-and-drop Internet shopping with an embedded shopping cart view;

FIGS. 2 and 3 illustrate how the virtual shopping cart can be relocated on the browser window in an example embodiment;

FIGS. 4 through 10 illustrate how the virtual shopping cart can be managed in the browser window of an example embodiment;

FIG. 11 illustrates another example embodiment of a networked system in which various embodiments may operate;

FIG. 12 is a processing flow chart illustrating an example embodiment of a virtual shopping cart management system as described herein; and

FIG. 13 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

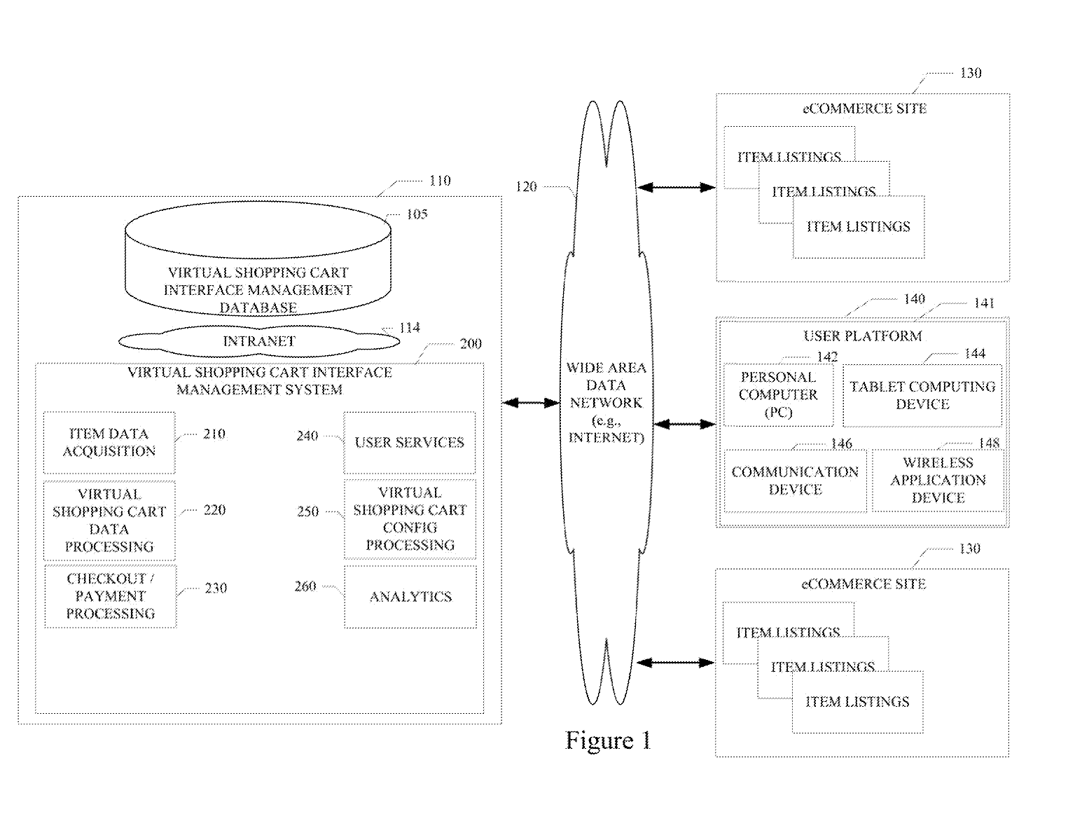

Referring to FIG. 1, in an example embodiment, a system and method for managing Internet shopping with an embedded shopping cart view are disclosed. In various example embodiments, an application or service, typically operating on a host site (e.g., a website) 110, is provided to simplify and facilitate Internet shopping with an embedded shopping cart view for a user at a user platform 140 from the host site 110. The host site 110 can thereby be considered a virtual shopping cart interface management site 110 as described herein. Multiple e-commerce sites 130 provide a plurality of item listings for which a user may browse and shop. VariouS conventional sites, such as Amazon.com, Safeway.com, and Sears.com are just a few examples of the available e-commerce sites 130. It will be apparent to those of ordinary skill in the art that e-commerce sites 130 can be any of a variety of networked product providers, service providers, or other e-commerce sites as described in more detail below. The virtual shopping cart interface management site 110, e-commerce sites 130, and user platforms 140 may communicate and transfer data and information via a wide area data network (e.g., the Internet) 120. Various components of the virtual shopping cart interface management site 110 can also communicate internally via a conventional intranet or local area network (LAN) 114.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent between computing devices. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital User Lines (DSLs), wireless links including satellite links, or other communication links known to those of ordinary skill in the art. Furthermore, remote computers and other related electronic devices can be remotely connected to either LANs or WANs via a modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to move freely and randomly and organize themselves arbitrarily, such that the topology of networks 120 and 114 may change rapidly.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example. The e-commerce sites 130 may include any of a variety of providers of e-commerce items.

In a particular embodiment, a user platform 140 with one or more client devices 141 enables a user to access content from the e-commerce sites 130 via the network 120. Client devices 141 may include virtually any computing device that is configured to send and receive information over a network, such as network 120. Such client devices 141 may include portable devices such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and several lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JavaScript, EXtensible HTML (xHTML), Compact HTML (CHTML), and the like, to display and send a message.

Client devices 141 may also include at least one client application that is configured to receive content or messages from another computing device via a network transmission. The client application may include a capability to provide and receive textual content, graphical content, video content, audio content, alerts, messages, notifications, and the like. Moreover, client devices 141 may be further configured to communicate and/or receive a message, such as through a Short Message Service (SMS), direct messaging (e.g., Twitter), email, Multimedia Message Service (MMS), instant messaging (IM), interne relay chat (IRC), mIRC, Jabber, Enhanced Messaging Service (EMS), text messaging, Smart Messaging, Over the Air (OTA) messaging, or the like, between another computing device, and the like.

Client devices 141 may also include a wireless application device 148 on which a client application is configured to enable a user of the device to access at least one of the e-commerce sites 130. Such access enables the user at user platform 140 to receive through the client device 141 at least a portion of the information provided by the e-commerce sites 130. Such information may include, but is not limited to, item listings, stock feeds, information articles, advertisements, shopping list prices, images, search results, blogs, or the like. Moreover, the information may be provided to client devices 141 using any of a variety of delivery mechanisms, including Short Message Service (SMS), wireless applications, and direct messaging (e.g., Twitter), instant messaging (IM), MMS, IRC, EMS, audio messages, HTML, XML, Java, Flash, email, or another networking application. Additionally, e-commerce site information can be provided to a user in response to a request from the user. In a particular embodiment, the application executable code used for e-commerce site access as described herein can itself be downloaded to the wireless application device 148 via network 120.

Referring still to FIG. 1, host site 110 of an example embodiment is shown to include a virtual shopping cart interface management system 200, intranet 114, and virtual shopping cart interface management database 105. Virtual shopping cart interface management system 200 includes item data acquisition module 210, virtual shopping cart data processing module 220, checkout/payment processing module 230, user services module 240, virtual shopping cart configuration processing module 250, and analytics module 260. Each of these modules can be implemented as software components executing within an executable environment of virtual shopping cart interface management system 200 operating on host site 110. Each of these modules of an example embodiment is described in more detail below in connection with the figures provided herein.

### DESCRIPTION OF AN EXAMPLE EMBODIMENT

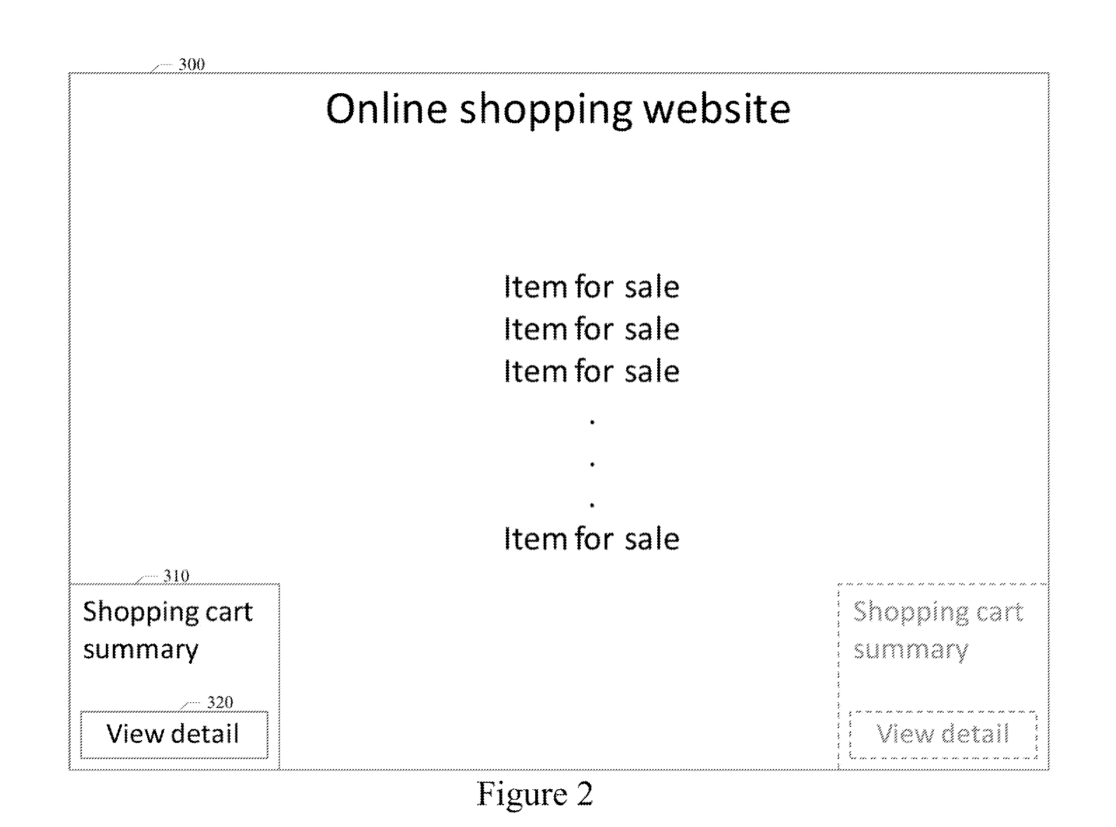

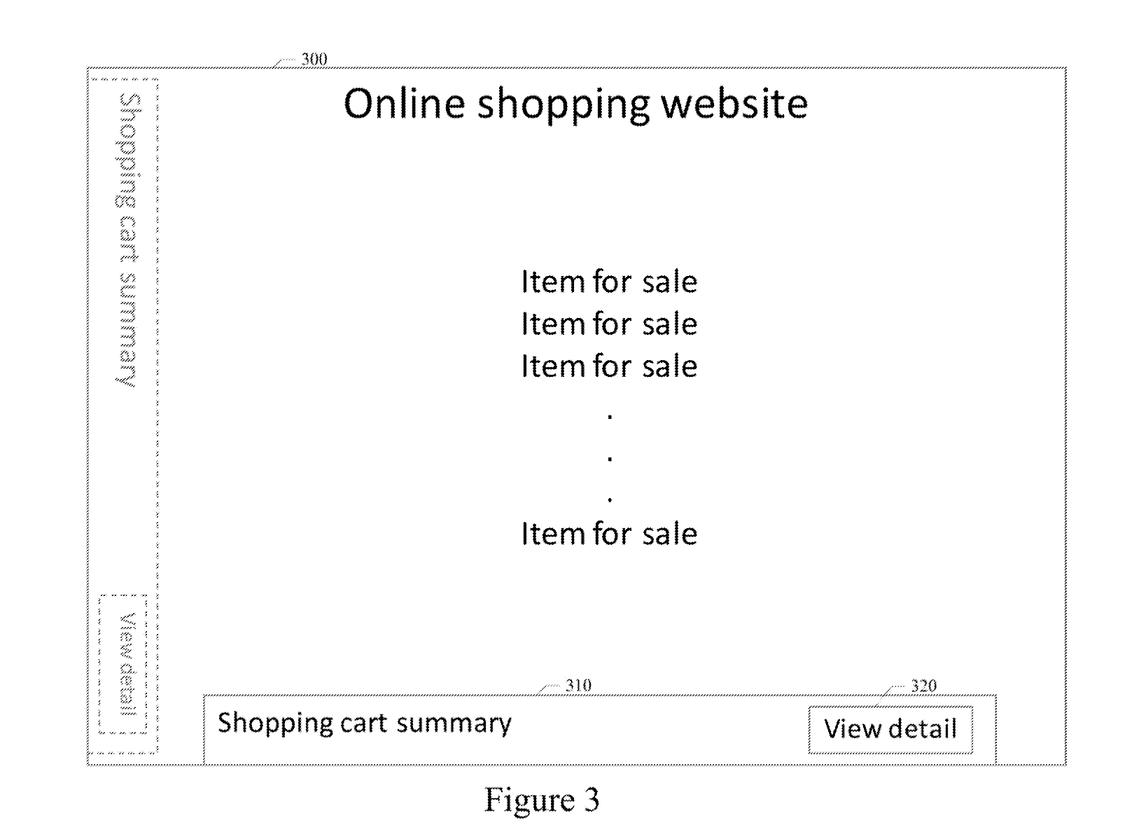

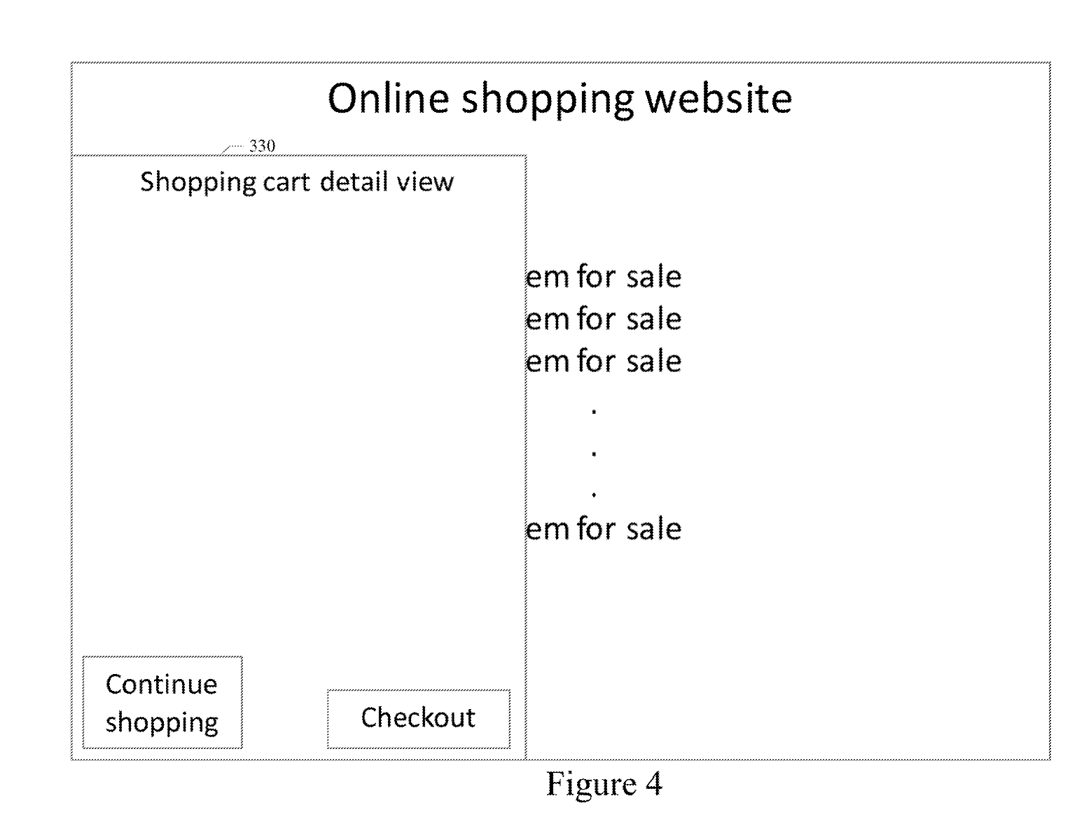

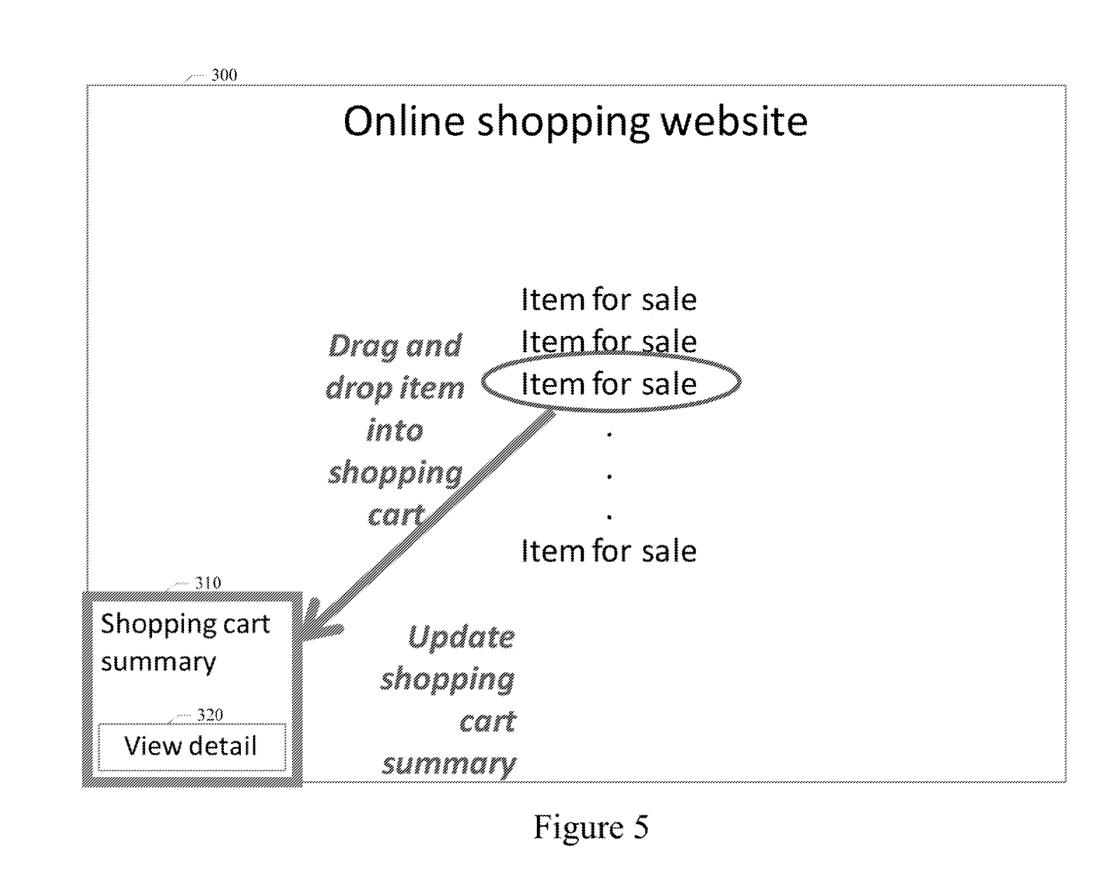

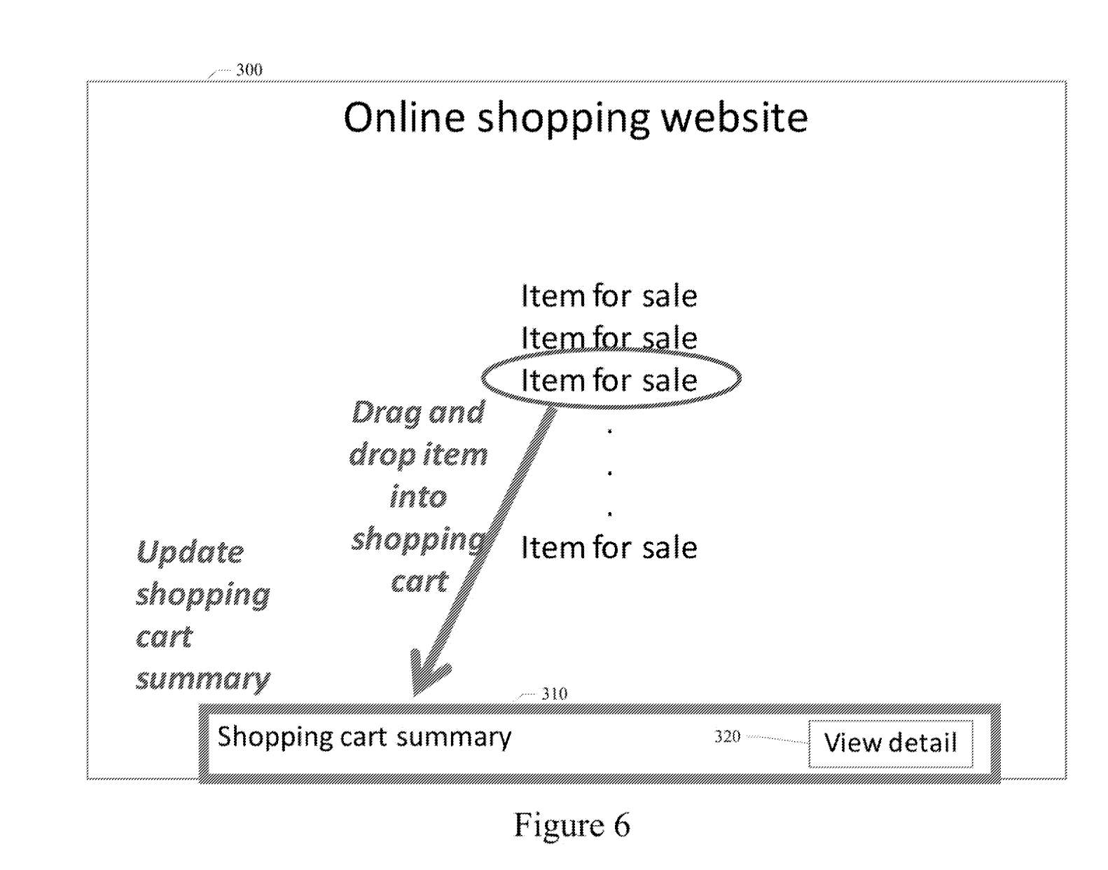

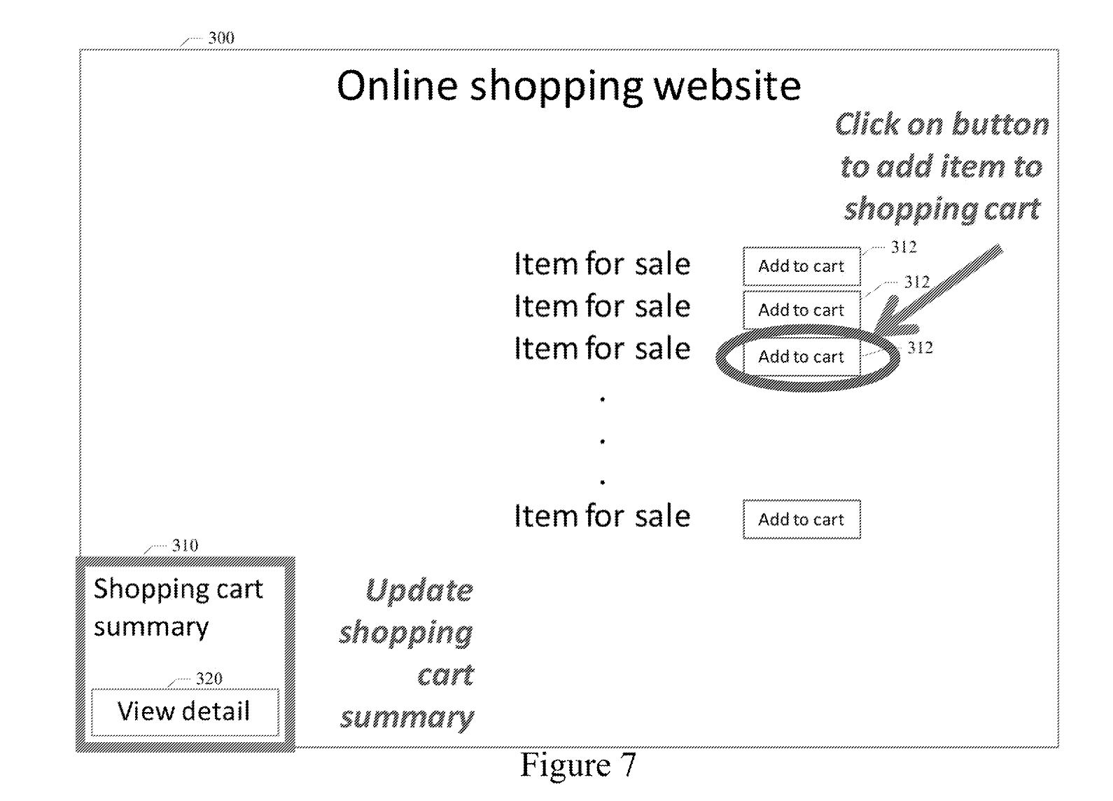

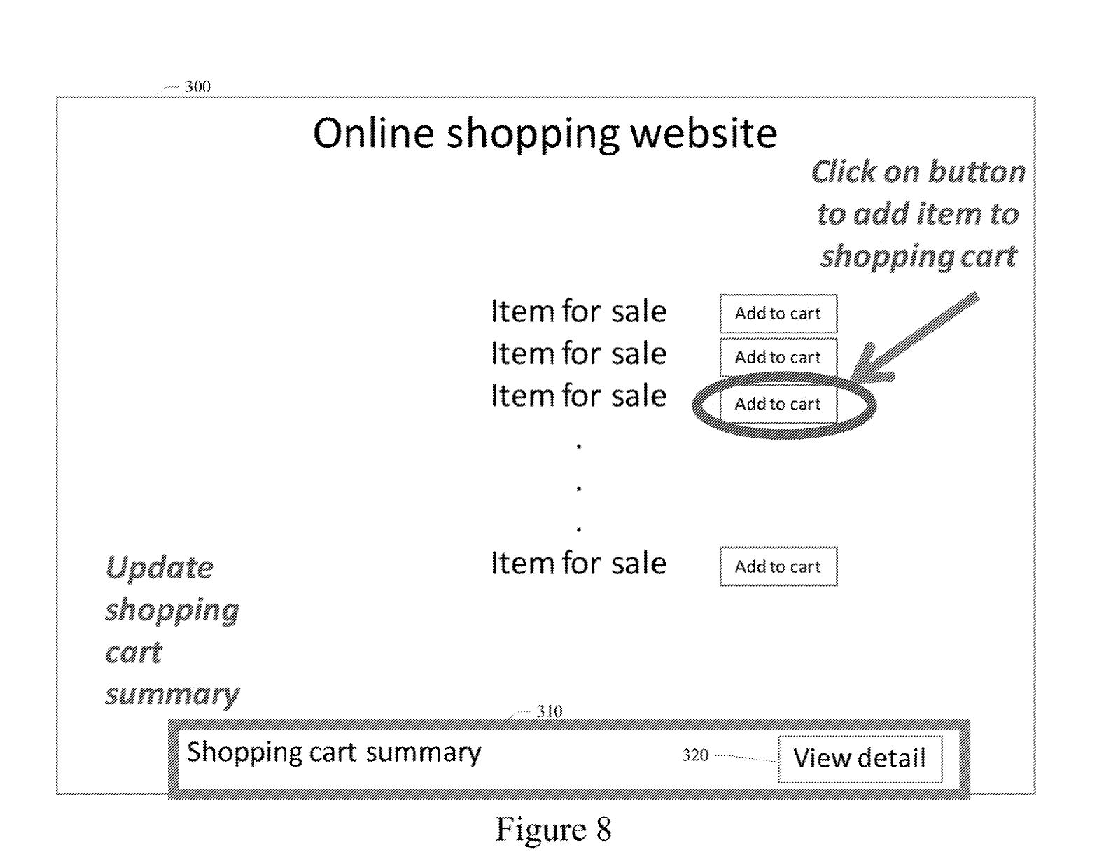

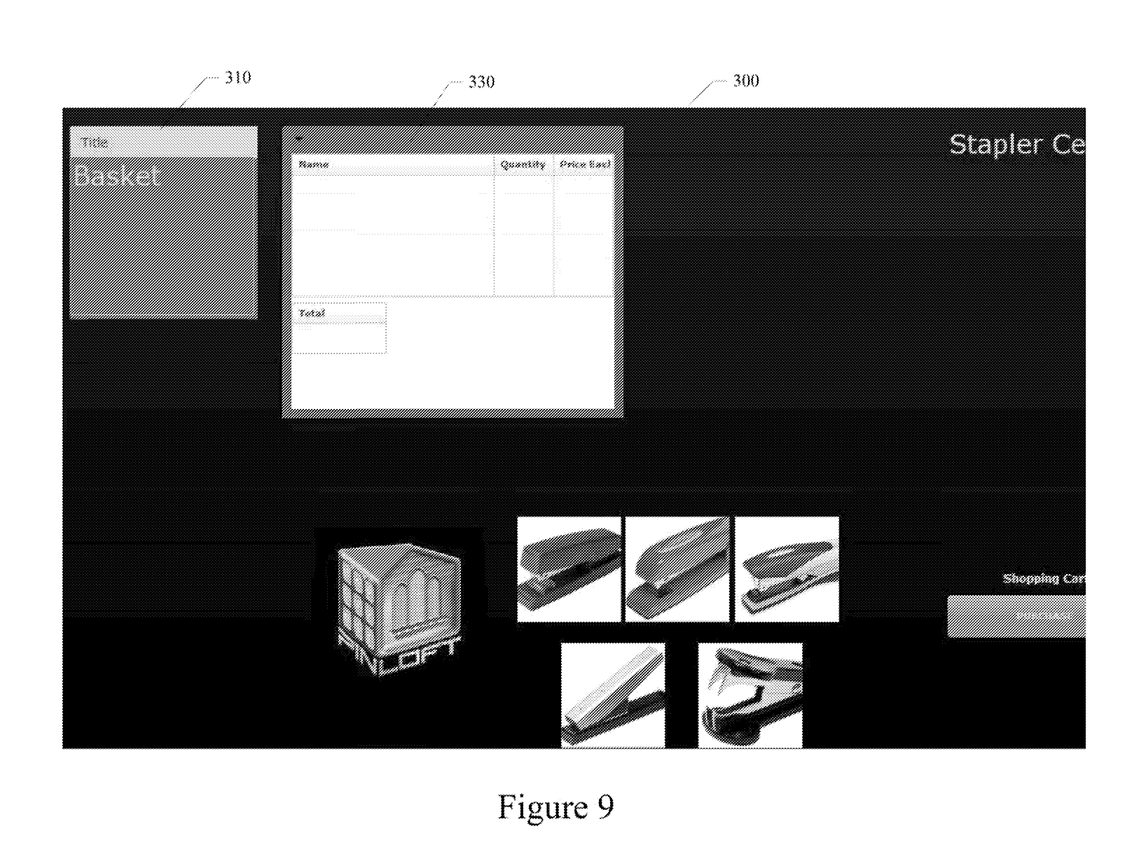

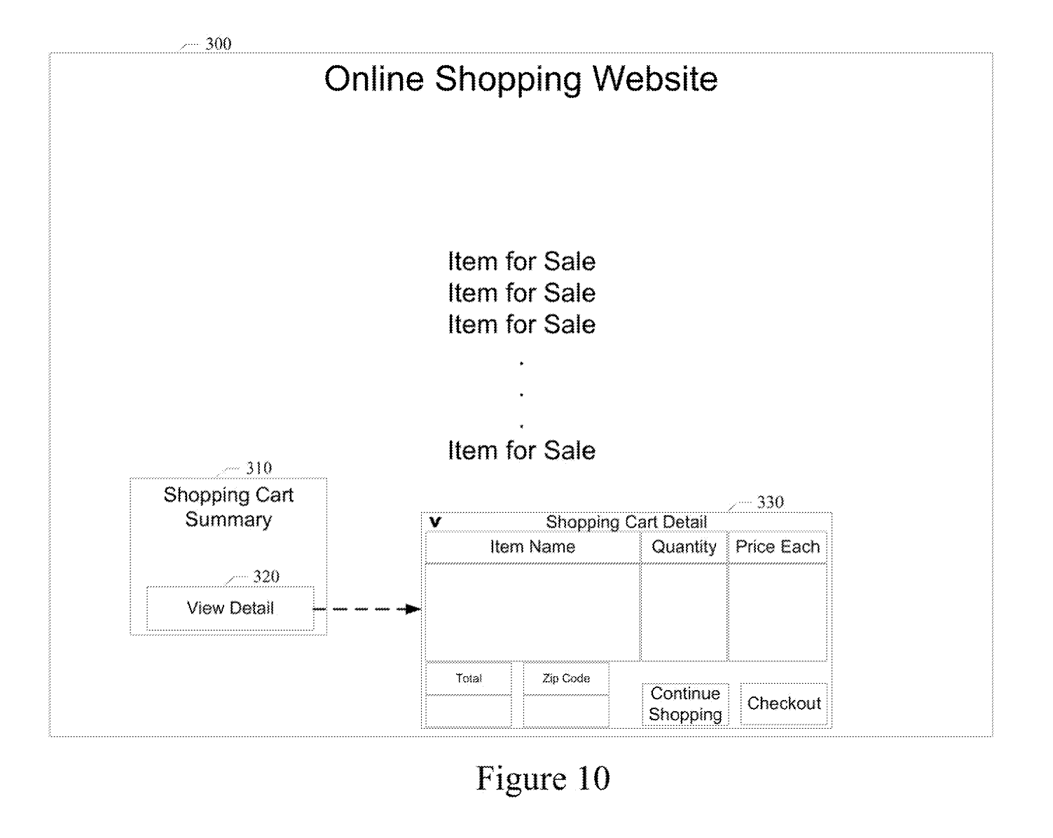

The new internet shopping experience as provided by the embodiments described herein is much more analogous to a shopping experience in a physical “bricks and mortar” store. This is achieved by implementing the user interface described herein on any kind of internet accessible device with a graphical user interface (e.g., desktop, laptop or tablet computer, web enabled cell phone or smart phone, etc.) running a web browser or internet shopping application. The user interface of a particular embodiment can provide the following features:
Display a shopping cart interactive display area (denoted herein as the “shopping cart” or “virtual shopping cart”) 310 in the same browser window 300 as the item(s) for sale. (see FIGS. 2 and 3)
This virtual shopping cart 310 is not an icon link; rather, the virtual shopping cart 310 is a small bordered interactive area or region within the browser window 300 that can display a summary of items placed in the virtual shopping cart 310 without occupying a large area relative to the browser window 300. (see FIGS. 2 and 3)
This virtual shopping cart 310 can be relocated or moved on or within the browser window 300 and will not scroll off the page. The virtual shopping cart 310 is always viewable and accessible on the browser window 300, yet the virtual shopping cart 310 is moveable within the browser window 300 to prevent information in the browser window 300 from being obscured. (see FIGS. 2 and 3)
The shopper can select the item to purchase and add the selected item into the virtual shopping cart 310 by dragging and dropping the item into the virtual shopping cart 310. (see FIGS. 5 and 6) Alternatively, the shopper can also select the item by clicking on a link or icon 312 to add item into the virtual shopping cart 310. (see FIGS. 7 and 8) Either action, however, will not change to a new web page, but rather trigger a visual, audio, or haptic response indicating that the item has been added to the virtual shopping cart 310.
The information set retained within the virtual shopping cart 310 can be enlarged or expanded in the same virtual shopping cart display region (e.g., see FIG. 4) or into an adjacent display region 330 (e.g., see FIGS. 9 and 10) in response to user action or automatically to show a detailed view, and allow the shopper to modify the content of their virtual shopping cart 310, shrink the detailed view to continue shopping, or go to checkout to complete their purchase. (see FIGS. 4, 9, and 10). A “View Detail” button 320, or other control mechanism provided by the virtual shopping cart 310, can be used by the user/shopper to enlarge or shrink (e.g., maximize or minimize) the display of information retained within the virtual shopping cart 310 to show or hide the detail information. As shown in FIGS. 9 and 10, the detail information shown can include a list of the item names currently in the virtual shopping cart 310, and an indication of the quantity and price of each item in the list. A total price and/or total quantity of all of the items in the list can also be shown in a “Total” field in the detail virtual shopping cart view 330 (e.g., see FIGS. 9 and 10). Additionally, the detail virtual shopping cart view 330 enables a user/shopper to enter a zip code or other location information into a data entry field provided by the detail virtual shopping cart view 330 (e.g., see FIG. 10). In response to the entry of a zip code or other location information, the detail virtual shopping cart view 330 can automatically update the “Total” information field to reflect the total cost of the items in the list plus the shipping costs incurred for transporting the listed items to the specified zip code or other location indicated by the location information. Additionally, in response to the entry of a zip code or other location information, the detail virtual shopping cart view 330 can automatically update the “Total” information field to reflect the total cost of the items in the list plus any tax or levy charge incurred for transporting the listed items to the specified zip code or other location indicated by the location information. As shown in FIG. 10, a “Continue Shopping” button can be used by the user/shopper to return to the browser window 300 to continue shopping. As also shown in FIG. 10, a “Checkout” button can be used by the user/shopper to complete the purchase of the items retained in the virtual shopping cart 310.
The preferences associated with the virtual shopping cart 310 can also be configured by the user. These preferences can be used to configure the shape, appearance, characteristics, and functionality of the virtual shopping cart 310 to suit a particular user. The user can also configure the language and/or monetary denominations (e.g., US dollars, British pounds, etc.) used to show the information in the detail virtual shopping cart view 330.
An analytics module can be employed to track user behavior and to retain information related to user behavior, user purchasing patterns, and usage of the virtual shopping cart 310.
In one embodiment, the virtual shopping cart 310 and its related functionality can be implemented as a plug-in, an embedded component, dynamically linked component, or a loaded application software component.

The user interface as described herein can also be used for any web application that generates a list whereby the user creates a list of items by selecting from a super set of items. Applications of the user interface include e-commerce websites, but such applications are not so limited.

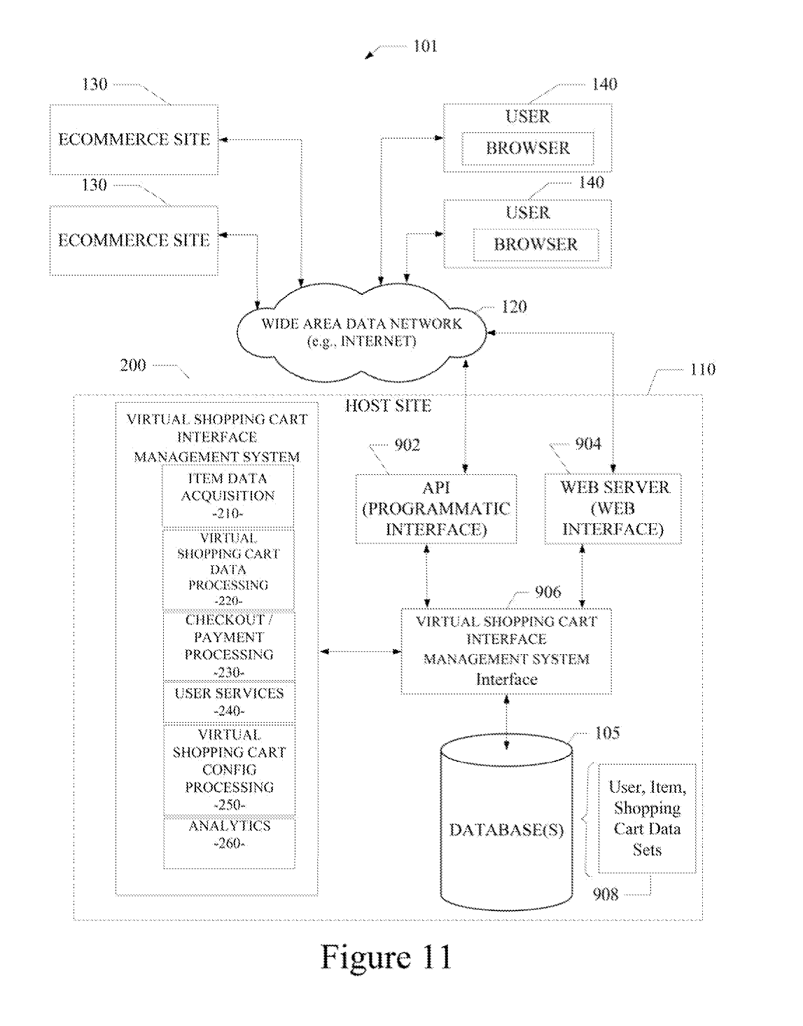

Referring now to FIG. 11, another example embodiment 101 of a networked system in which various embodiments may operate is illustrated. In the embodiment illustrated, the host site 110 is shown to include the virtual shopping cart interface management system 200. The virtual shopping cart interface management system 200 is shown to include the functional components 210-260. In a particular embodiment, the host site 110 may also include a web server 904, having a web interlace with which users may interact with the host site 110 via a user interface or web interface. The host site 110 may also include an application programming interface (API) 902 with which the host site 110 may interact with other network entities on a programmatic or automated data transfer level. The API 902 and web interface 904 may be configured to interact with the virtual shopping cart interface management system 200 either directly or via an interface 906. The virtual shopping cart interface management system 200 may be configured to access a data storage device 105 either directly or via the interface 906.

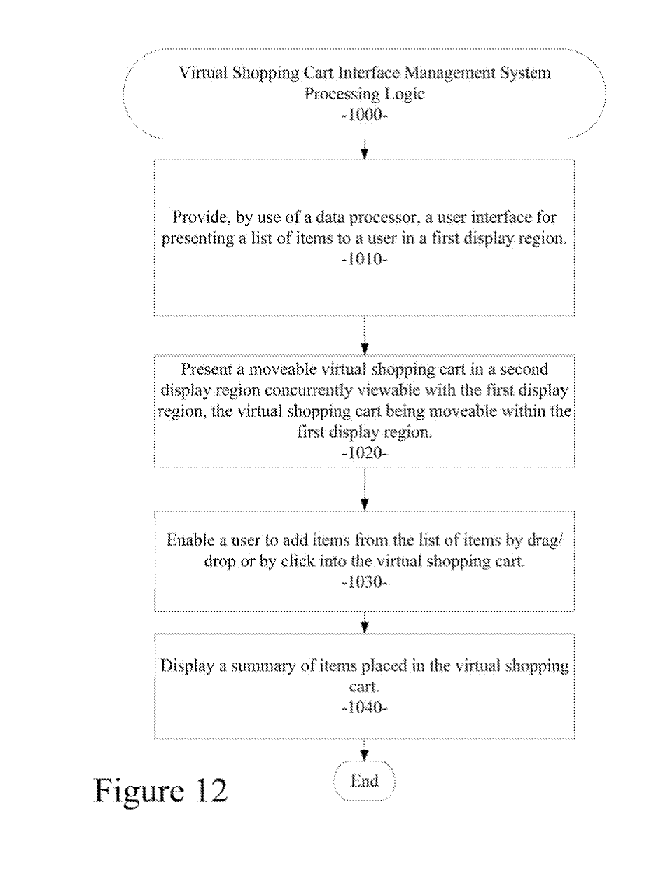

FIG. 12 is a processing flow diagram illustrating an example embodiment of a virtual shopping cart interface management system as described herein. The method of an example embodiment includes providing, by use of a data processor, a user interface for: presenting a list of items to a user in a first display region (processing block 1010); presenting a moveable virtual shopping cart in a second display region concurrently viewable with the first display region, the virtual shopping cart being moveable within the first display region (processing block 1020); enabling a user to add items from the list of items by drag/drop or click into the virtual, shopping cart (processing block 1030); and displaying a summary of items placed in the virtual shopping cart (processing block 1040).

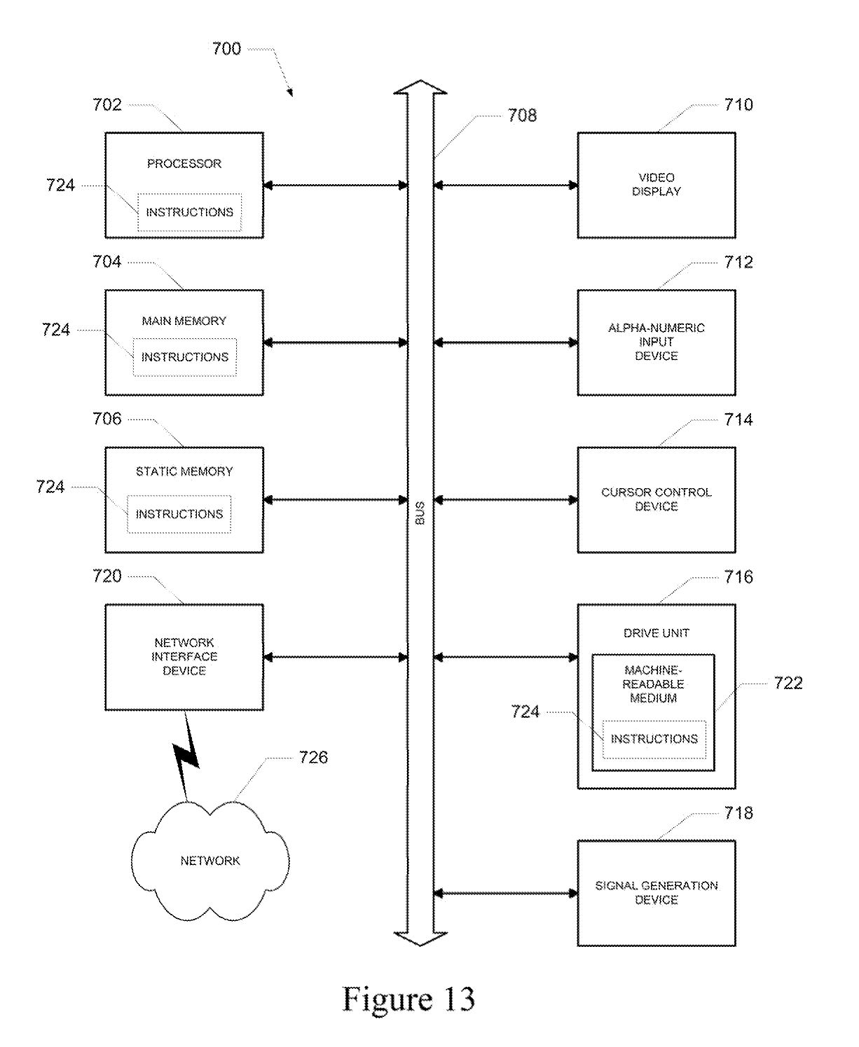

FIG. 13 shows a diagrammatic representation of machine in the example form of a computer system 700 within which a set of instructions when executed may cause the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” can also be taken to include any collection of machines that individually or jointly execute a set (or multiple sets) of instructions to perform any one or more of the methodologies discussed herein.

The example computer system 700 includes a data processor 702 (e.g., a central processing unit (CPU), a graphics processing unit (CPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 also includes an input device 712 (e.g., a keyboard), a cursor control device 714 (e.g., a mouse), a disk drive unit 716, a signal generation device 718 (e.g., a speaker) and a network interface device 720.

The disk drive unit 716 includes a non-transitory machine-readable medium 722 on which is stored one or more sets of instructions (e.g., software 724) embodying any one or more of the methodologies or functions described herein. The instructions 724 may also reside, completely or at least partially, within the main memory 704, the static memory 706, and/or within the processor 702 during execution thereof by the computer system 700. The main memory 704 and the processor 702 also may constitute machine-readable media. The instructions 724 may further be transmitted or received over a network 726 via the network interface device 720. While the machine-readable medium 722 is shown in an example embodiment to be a single medium, the term “machine-readable medium” should be taken to include a single non-transitory medium or multiple media (e.g., a centralized or distributed database, and/or associated caches and servers) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method comprising:
providing, by use of a data processor, a user interface for:
presenting a list of items to a user in a first display region;
presenting a moveable virtual shopping cart in a second display region concurrently viewable with the first display region, the virtual shopping cart being moveable within the first display region;
enabling a user to add items from the list of items by drag/drop or by click into the virtual shopping cart; and
displaying a summary of items placed in the virtual shopping cart.

2. The method of claim 1 including enabling the user to activate a control mechanism provided by the virtual shopping cart to cause a display of more detailed information as retained within the virtual shopping cart.

3. The method of claim 2 wherein the more detailed information is displayed within the second display region.

4. The method of claim 2 wherein the more detailed information is displayed within a third display region adjacent to the second display region.

5. The method of claim 2 wherein the display of the more detailed information can be maximized or minimized using the control mechanism.

6. The method of claim 2 wherein the more detailed information includes a list of item names currently retained within the virtual shopping cart.

7. The method of claim 2 wherein the more detailed information includes an indication of the quantity and price of each item currently retained within the virtual shopping cart.

8. The method of claim 2 wherein the more detailed information includes an indication of the total price of all items currently retained within the virtual shopping cart.

9. The method of claim 8 including enabling the user to enter location information into a data entry field provided by the virtual shopping cart, the entry of the location information automatically causing the indication of the total price to be updated to indicate a total price of all items currently retained within the virtual shopping cart plus a shipping cost to transport all items currently retained within the virtual shopping cart to a location indicated by the location information.

10. The method of claim 8 including enabling the user to enter location information into a data entry field provided by the virtual shopping cart, the entry of the location information automatically causing the indication of the total price to be updated to indicate a total price of all items currently retained within the virtual shopping cart plus any tax or levy charge to transport all items currently retained within the virtual shopping cart to a location indicated by the location information.

11. The method of claim 1 wherein the virtual shopping cart is implemented as a plug-in or embedded component.

12. A system comprising:
a data processor;
a database, in data communication with the processor, for storage of item information; and
a user interface, executable by the processor, to:
present a list of items to a user in a first display region;
present a moveable virtual shopping cart in a second display region concurrently viewable with the first display region, the virtual shopping cart being moveable within the first display region;
enable a user to add items from the list of items by drag/drop or click into the virtual shopping cart; and
display a summary of items placed in the virtual shopping cart.

13. The system of claim 12 being configured to enable the user to activate a control mechanism provided by the virtual shopping cart to cause a display of more detailed information as retained within the virtual shopping cart.

14. The system of claim 13 wherein the more detailed information includes an indication of the quantity and price of each item currently retained within the virtual shopping cart.

15. The system of claim 13 wherein the more detailed information includes an indication of the total price of all items currently retained within the virtual shopping cart.

16. The system of claim 15 being configured to enable the user to enter location information into a data entry field provided by the virtual shopping cart, the entry of the location information automatically causing the indication of the total price to be updated to indicate a total price of all items currently retained within the virtual shopping cart plus a shipping cost to transport all items currently retained within the virtual shopping cart to a location indicated by the location information.

17. The system of claim 15 being configured to enable the user to enter location information into a data entry field provided by the virtual shopping cart, the entry of the location information automatically causing the indication of the total price to be updated to indicate a total price of all items currently retained within the virtual shopping cart plus any tax or levy charge to transport all items currently retained within the virtual shopping cart to a location indicated by the location information.

18. The system of claim 12 wherein the virtual shopping cart is implemented as a plug-in or embedded component.

19. A non-transitory machine-useable storage medium embodying instructions which, when executed by a machine, cause the machine to:
provide a user interface to enable a user to:
present a list of items to a user in a first display region;
present a moveable virtual shopping cart in a second display region concurrently viewable with the first display region, the virtual shopping cart being moveable within the first display region;
enable a user to add items from the list of items by drag-and-drop or click into the virtual shopping cart; and
display a summary of items placed in the virtual shopping cart.

20. The machine-useable storage medium of claim 19 wherein the instructions being configured to enable the user to activate a control mechanism provided by the virtual shopping cart to cause a display of more detailed information as retained within the virtual shopping cart.
